(19) United States
(12) Patent Application Publication
(10) Pub. No.: US 2007/0169824 A1
(43) Pub. Date: Jul. 26, 2007

(54) Backflow preventing device for solenoid valve

(76) Inventors: Gwan Ho Ro, Seoul (KR); Young Sik Nam, Suwon (KR)

Correspondence Address: Dykema Gossett PLLC;Third Floor West, Franklin Square, 1300 I Street, N.W., Washington, DC, 20005-3353, US

(21) Appl. No.: 11/542,597

(22) Filed: Oct. 4, 2006

(30) Foreign Application Priority Data
Jan. 26, 2006 (KR) 2006-8087

(51) Int. Cl. F16K 1/30

(52) U.S. Cl. 137/614.2

(57) ABSTRACT

Disclosed is a backflow preventing device for a solenoid valve. The solenoid valve includes a solenoid valve including a body having an inlet port, an outlet port, and a valve seat interposed between the inlet port and the outlet port, and an opening part mounted on the body and having a plunger moved by an electromagnet and a spring. The backflow preventing device includes a closure of rubber mounted between the inlet port and the outlet port, and having a fluid supply line which is opened by supply pressure of a fluid and is closed by its resilience if supply of a fluid is not stopped. The rubber closure is mounted between the inlet port and the outlet port to prevent the backflow of the fluid in the solenoid and interrupt a pollution source resulted from the backflow of the fluid.

### BACKGROUND OF THE INVENTION

1. Field of the Invention

The present invention relates to a solenoid valve for opening or closing a supply pipe of a fluid in response to an electric signal, and more particularly, to a backflow preventing device built in a closure of a solenoid valve which can prevent a backflow of a fluid due to a pressure difference between an inlet port and an outlet port.

2. Background of the Related Art

A solenoid valve is generally installed in a water supply pipe of an automatic water supply apparatus to control a flow of a fluid in response to an electric signal. Such a solenoid valve is installed in a terminal end of a water supply system, such as water service pipe, or a water supply part of an apparatus. In particular, the solenoid valve is widely used in a refrigerator, a washing machine, a vending machine, and other apparatus requiring for water supply

Referring to FIG. 1, a solenoid valve 100 includes a body 110 having an inlet port 111, an outlet port 112, and a valve seat 113 interposed between the inlet port 111 and the outlet port 112, and an opening part 120 mounted on the body 110 and having a plunger 123 moved by an electromagnet 121 and a spring 122.

With the above arrangement of the solenoid valve, a passage through which the fluid supplied to the inlet port 111 of the body 110 flows is interrupted if the plunger 123 closely contacts the valve seat 113 by biasing force of the spring 122, but is opened if the plunger 123 is spaced apart from the valve seat 113 by magnetic force of the electromagnet 121.

In case the internal pressure of the valve is relatively higher than resilience of the spring 122, and thus the plunger is spaced apart from the valve seat, a backflow phenomenon takes place in the solenoid valve 100. In this instance, there are problems in that the pipes of the inlet and outlet ports 112 and 122 and the peripheral appliance are polluted to reduce its reliability and the lifespan of the solenoid valve is shortened due to valve trouble.

Therefore, backflow preventing devices have been proposed as a means for preventing the backflow phenomenon in the solenoid valve. Most of the backflow preventing devices do not satisfy the watertight performance, as well as its complicated and expensive construction.

### SUMMARY OF TH INVENTION

Accordingly, the present invention is directed to a backflow preventing device for a solenoid valve that substantially obviates one or more problems due to limitations and disadvantages of the related art.

An object of the present invention is to provide a backflow preventing device built in a closure of a solenoid valve which can prevent a backflow of a fluid due to a pressure difference between an inlet port and an outlet port.

To achieve the object and other advantages, according to one aspect of the present invention, there is provided a backflow preventing device including a closure of rubber mounted between an inlet port and an outlet port, and having a fluid supply line which is opened by supply pressure of a fluid and is closed by its resilience if supply of a fluid is not stopped.

Another aspect of the present invention, there is provided a backflow preventing device including a closure of rubber mounted between an inlet port and an outlet port, and moved backward by pressure of a fluid supplied from the inlet port to open the inlet port, and is returned by the spring to close the inlet port if supply of a fluid is stopped.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a cross-sectional view of a conventional solenoid valve;

FIG. 2 is a cross-sectional view of a solenoid valve equipped with a backflow preventing device according to a first embodiment of the present invention;

FIGS. 3a and 3b are cross-sectional views illustrating the operation of the solenoid valve shown in FIG. 2;

FIG. 4 is a cross-sectional view of a solenoid valve equipped with a backflow preventing device according to a second embodiment of the present invention; and

FIGS. 5a and 5b are cross-sectional views illustrating the operation of the solenoid valve shown in FIG. 4.

### DETAILED DESCRIPTION OF THE PREFERRED EMBODIMENTS

A preferred embodiment according to the present invention will now be explained with reference to the accompanying drawings.

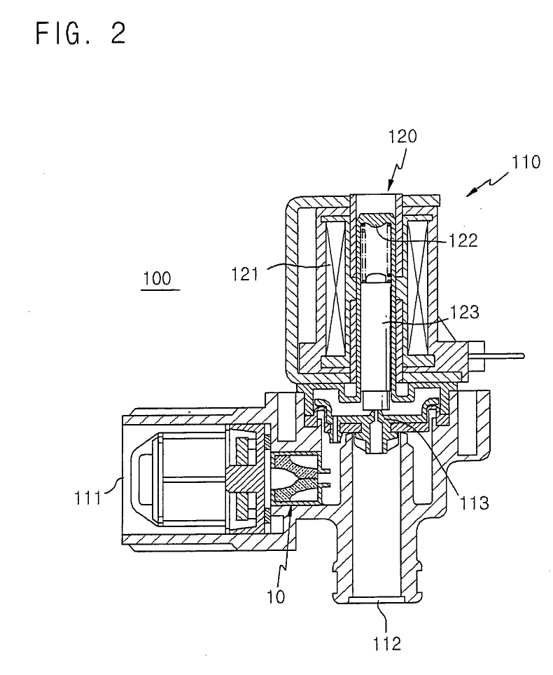

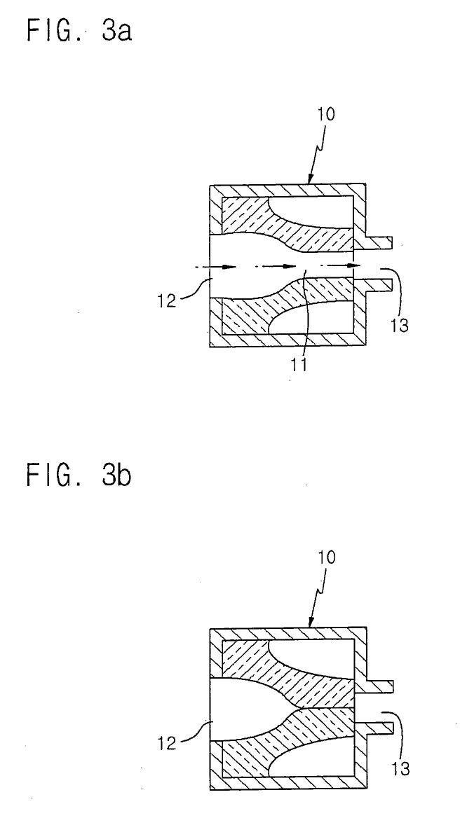

FIG. 2 is a cross-sectional view of a solenoid valve equipped with a backflow preventing device according to a first embodiment of the present invention, and FIGS. 3a and 3b are cross-sectional views illustrating the operation of the solenoid valve shown in FIG. 2.

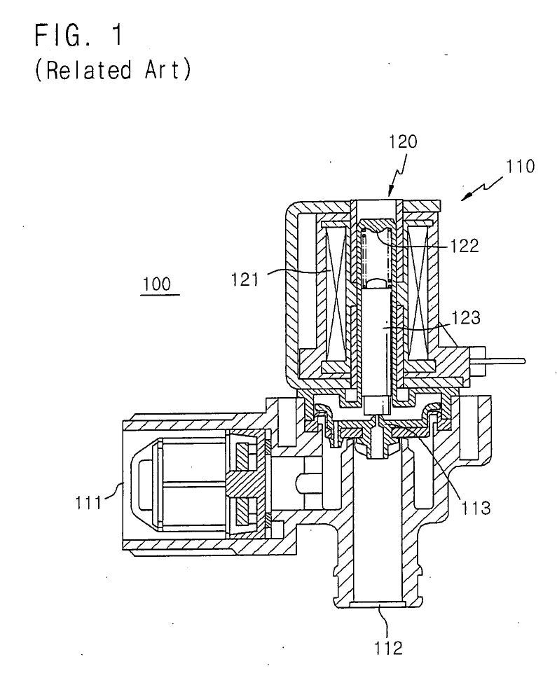

Referring to FIGS. 1 and 2, a solenoid valve 100 includes a body 110 having an inlet port 111, an outlet port 112, and a valve seat 113 interposed between the inlet port 111 and the outlet port 112, and an opening part 120 mounted on the body 110 and having a plunger 123 moved by an electromagnet 121 and a spring 122. A closure 10 of rubber is mounted between the inlet port 111 and the outlet port 112, and has a fluid supply line 11 which can be opened by supply pressure of a fluid and closed by its resilience if the fluid is not supplied.

The body 110 and the opening part 120 of the solenoid valve 100 are identical to those of the related art, except for the closure 10 mounted in the body 110 for preventing backflow of the fluid.

The closure 10 is mounted in a space formed between the inlet port 111 and the outlet port 112 to open or close the supply passage of the fluid and prevent the backflow of the fluid. The closure 10 has a cylindrical shape which can be tightly fitted into the space between the inlet port 111 and the outlet port 112.

The closure 10 has an inlet 12 corresponding to the inlet port 111 at one side thereof and an outlet 13 corresponding to the outlet port 112 at the other side thereof. A fluid supply line 11 is formed between the inlet 12 and the outlet 13 and is opened or closed by the supply of the fluid or interruption of the fluid.

Preferably, the closure 10 is made of a good elastic material, such as rubber, in such a way that expansion and retraction are easily performed.

The fluid supply line 111 may be provided with a plurality of cut portions along the center portion thereof, as viewing from the outlet 13, so that it maximizes the efficiency of the compression when the supply of the fluid is stopped.

The fluid supply line 11 may be shaped in such a way that its cross section is gradually decreased towards its rear portion.

Operation of the backflow preventing device according to the first embodiment will now be described.

If a fluid is supplied to an electrical equipment such as washing machine or refrigerator, the fluid fed to the inlet port 111 of the solenoid valve 100 flows through the closure 10, and is discharged to the outlet port 112.

In this instance, when the pressure of the fluid fed to the inlet port 111 of the solenoid valve 100 is higher than that of the fluid discharged to the outlet port 112, the fluid supply line 11 of the closure 10 is maintained in an opened state, as shown in FIG. 3a.

Otherwise, when the pressure of the fluid fed to the inlet port 111 of the solenoid valve 100 is lower than that of the fluid discharged to the outlet port 112, the fluid supply line 11 of the closure 10 is maintained in a closed state, as shown in FIG. 3b.

Consequently, the flow of the fluid discharged to the outlet port 112 of the solenoid 100 is determined by the resilience of the closure 10 and the supply pressure of the fluid. Although the plunger 123 is spaced apart from the valve seat, the backflow of the fluid is prevented.

That is, although the internal pressure of the vale is higher relative to the resilience of the spring 122, the fluid supply line 11 is closed when the supply of the fluid is stopped. Therefore, there is not backflow of the fluid.

A second embodiment of the present invention will now be described.

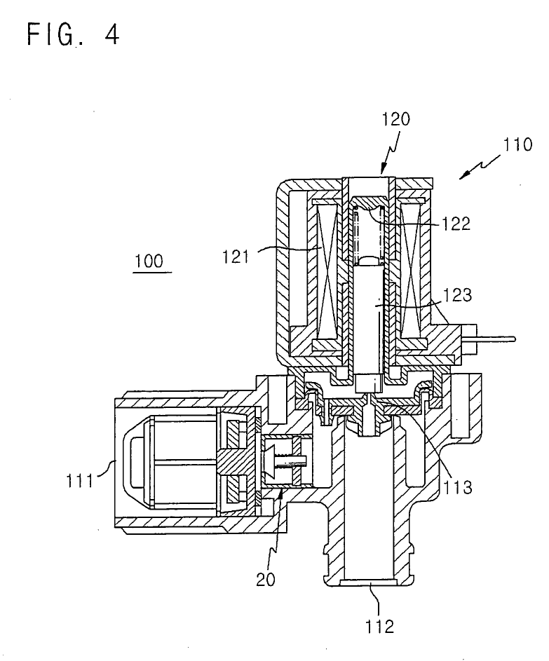

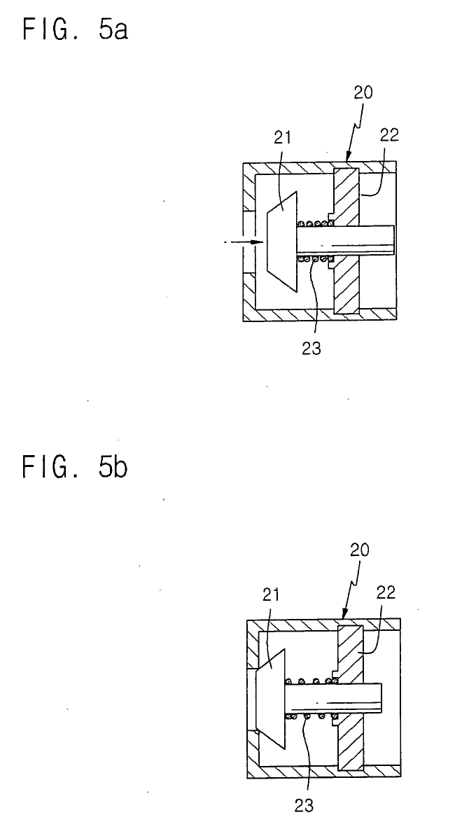

FIG. 4 is a cross-sectional view of a solenoid valve equipped with a backflow preventing device according to another embodiment of the present invention, and FIGS. 5a and 5b are cross-sectional views illustrating the operation of the solenoid valve shown in FIG. 4.

Referring to FIGS. 4 and 5, a solenoid valve 100 includes a body 110 having an inlet port 111, an outlet port 112, and a valve seat 113 interposed between the inlet port 111 and the outlet port 112, and an opening part 120 mounted on the body 110 and having a plunger 123 moved by an electromagnet 121 and a spring 122. A closure 20 of rubber is mounted between the inlet port 111 and the outlet port 112, and is moved backward by pressure of a fluid supplied from the inlet port 111 to open the inlet port 111, and is returned by the spring 23 to close the inlet port 111 if the supply of the fluid is stopped.

The body 110 and the opening part 120 of the solenoid valve 100 are identical to those of the related art, except for the closure 20 mounted in the body 110 for preventing backflow of the fluid.

The closure 20 is mounted in a space formed between the inlet port 111 and the outlet port 112 to open or close the supply passage of the fluid and prevent the backflow of the fluid. The closure 20 has a cylindrical shape which can be tightly fitted into the space between the inlet port 111 and the outlet port 112.

The closure 20 has an inlet 12 corresponding to the inlet port 111 at one side thereof and an outlet 13 corresponding to the outlet port 112 at the other side thereof. A fluid supply line 11 is formed between the inlet 12 and the outlet 13 and is opened or closed by the supply of the fluid or interruption of the fluid.

Preferably, the closure 20 is made of the same material as that of the closure 10 shown in the first embodiment. The closure 20 has the same construction as that of the closure 10 of the first embodiment, except for the fluid supply line 11 formed in the closure of the first embodiment 1.

The closure 20 has a plug rod 21 reciprocating along a guide 22 provided at a rear side of the closure 20. The plug rod 21 is inserted into a compress spring 23 so that the plug rod 21 provides contact force to the inlet port 111. Preferably, the plug rod 21 is slidably moved along a through hole of the guide 22.

The closure 20 may be a good elastic material in such a way that expansion and retraction are easily performed. The closure 20 is made in a dome shape to have a round end at a front side.

Operation of the backflow preventing device according to the second embodiment will now be described.

If a fluid is supplied to an electrical equipment such as washing machine or refrigerator, the fluid fed to the inlet port 111 of the solenoid valve 100 flows through the closure 20, and is discharged to the outlet port 112.

In this instance, when the pressure of the fluid fed to the inlet port 111 of the solenoid valve 100 is higher than that of the fluid discharged to the outlet port 112, the closure 20 is moved backward against the resilience of the spring 23 to open the inlet port 111, as shown in FIG. 5a.

Otherwise, when the pressure of the fluid fed to the inlet port 111 of the solenoid valve 100 is lower than that of the fluid discharged to the outlet port 112, the closure 20 is returned by the resilience of the spring 23 to close the inlet port 111, as shown in FIG. 5b.

Consequently, the flow of the fluid discharged to the outlet port 112 of the solenoid 100 is determined by the resilience of the spring 23 and the supply pressure of the fluid. Although the plunger 123 is spaced apart from the valve seat, the backflow of the fluid is prevented.

That is, although the internal pressure of the vale is higher relative to the resilience of the spring 122, the inlet port 111 is closed by the closure 20 when the supply of the fluid is stopped. Therefore, there is not backflow of the fluid.

As described above, according to the backflow preventing device for the solenoid valve of the present invention, the rubber closure is mounted between the inlet port and the outlet port to prevent the backflow of the fluid in the solenoid and interrupt a pollution source resulted from the backflow of the fluid. In addition, since the backflow preventing device has a simple construction, its manufacturing cost is reduced. Also, since the inlet port of the solenoid valve is closed by the rubber closure, the watertight performance is improved, thereby increasing the reliability of the valve.

The forgoing embodiment is merely exemplary and is not to be construed as limiting the present invention. The present teachings can be readily applied to other types of apparatus. The description of the present invention is intended to be illustrative, and not to limit the scope of the claims. Many alternatives, modifications, and variations will be apparent to those skilled in the art.

1. A backflow preventing device for a solenoid valve including a solenoid valve which includes a body having an inlet port, an outlet port, and a valve seat interposed between the inlet port and the outlet port, and an opening part mounted on the body and having a plunger moved by an electromagnet and a spring, the backflow preventing device comprising:
a closure of rubber mounted between the inlet port and the outlet port, and having a fluid supply line which is opened by supply pressure of a fluid and is closed by its resilience if supply of a fluid is not stopped.

2. A backflow preventing device for a solenoid valve including a solenoid valve which includes a body having an inlet port, an outlet port, and a valve seat interposed between the inlet port and the outlet port, and an opening part mounted on the body and having a plunger moved by an electromagnet and a spring, the backflow preventing device comprising:
a closure of rubber mounted between the inlet port and the outlet port, and moved backward by pressure of a fluid supplied from the inlet port to open the inlet port, and is returned by the spring to close the inlet port if supply of a fluid is stopped.
